(19) United States
(12) Patent Application Publication
(10) Pub. No.: US 2025/0315316 A1
(43) Pub. Date: Oct. 9, 2025

(54) Autonomous Transparent Cluster Resizing for In-Memory Distributed Graph Processing Systems

(71) Applicant: Oracle International Corporation, Redwood Shores, CA (US)

(72) Inventors: Petr Koupy, Zurich (CH); Calin Iorgulescu, Zurich (CH); Arnaud Delamare, Zurich (CH); Jinsu Lee, Belmont, CA (US); Michiel Haisma, Zurich (CH); Vasileios Trigonakis, Zurich (CH); Korbinian Schmid, Austin, TX (US); Sungpack Hong, Palo Alto, CA (US); Alexander Weld, Zurich (CH); Francisco Riestra, Guadalajara (MX)

(21) Appl. No.: 18/629,734

(22) Filed: Apr. 8, 2024

(51) Int. Cl. G06F 9/50; G06F 9/455; G06F 9/48; G06F 16/901

(52) U.S. Cl. CPC G06F 9/5088; G06F 9/45558; G06F 9/4856; G06F 9/5016; G06F 9/5027; G06F 9/5072; G06F 16/9024; G06F 2009/45562; G06F 2209/503

(57) ABSTRACT

An elastic distributed graph processing system deployment includes an external control plane that is responsible for controlling the resources that the graph processing system uses. The control plane responds to resource information provided by the graph processing system by giving resources or taking away resources from the graph processing system. Graph operations that cannot continue due to lack of resources are paused and later resumed after the cluster grows, manifesting only an increased latency from a user perspective. Determining which cluster members will participate in the operation processing is driven by extending presence of the objects involved in the operation on a just-in-time basis before the operation starts. The objects involved in and resulting from the graph operations form a hierarchy of transitively dependent objects, which must be considered when extending their presence.

### FIELD OF THE INVENTION

The present invention relates to in-memory distributed graph processing systems and, more specifically, to autonomous transparent cluster resizing for in-memory distributed graph processing systems.

### BACKGROUND

A graph database is a database that uses graph structures for semantic queries with nodes, edges, and properties to represent and store data. A graph relates data items in the store to a collection of nodes and edges, the edges representing the relationships between the nodes. The relationships allow data in the store to be linked together directly and, in many cases, retrieved with one operation. Graph databases hold the relationships between data as a priority. The underlying storage mechanism of graph databases can vary. Relationships are a first-class citizen in a graph database and can be labeled, directed, or given properties. Some implementations use a relational engine and store the graph data in a table.

Many applications of graph database processing involve processing increasingly large graphs that do not fit in a single machine's memory. Distributed graph processing engines partition the graph among multiple machines and execute graph processing operations in the multiple machines, potentially in parallel, with communication of intermediate results between machines. Distributed graph processing engines can be implemented in cloud environments to provide dynamic scalability as graph sizes increase.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 is a block diagram illustrating an example elasticity scenario in which two users issue operations, triggering elasticity due to lack of memory in accordance with an illustrative embodiment.

FIG. 2A illustrates an example of monitoring memory and resource requirements for a graph processing system cluster in accordance with an illustrative embodiment.

FIG. 2B illustrates an example of providing additional resources to a graph processing system for cluster resizing in accordance with an illustrative embodiment.

FIG. 3 is a data flow diagram illustrating an example of adding cluster members to a distributed graph processing system in accordance with an illustrative embodiment.

FIG. 4 illustrates an example of an object dependency hierarchy with different types of dependency relationships in accordance with an illustrative embodiment.

FIG. 5A illustrates an example of determining a group membership descriptor for an operation retrieving a vertex from a vertex collection in accordance with an illustrative embodiment.

FIG. 5B illustrates an example of determining a group membership descriptor for an operation cloning a graph in accordance with an illustrative embodiment.

FIG. 6 is a data flow diagram illustrating an example of removing a cluster member from a distributed graph processing system in accordance with an illustrative embodiment.

FIG. 7 is a flowchart illustrating of a graph processing system performing a graph operation with autonomous transparent cluster resizing in accordance with an illustrative embodiment.

FIG. 8 is a block diagram that illustrates a computer system upon which aspects of the illustrative embodiments may be implemented.

FIG. 9 is a block diagram of a basic software system that may be employed for controlling the operation of a computer system in accordance with an illustrative embodiment.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

In an in-memory distributed graph processing system, memory (and other resources, such as central processing unit (CPU) and network bandwidth resources) required for processing a particular operation, such as graph loading operation, graph processing algorithm, or graph query operation, are difficult to predict and tend to significantly vary during different processing phases. Using a static cluster of machines for such systems leads either to unnecessary over-provisioning of resources or to failing the processing due to lack of resources. The illustrative embodiments provide mechanisms to dynamically adapt the cluster size of a graph processing system depending on the currently required resources, with a focus on memory, and to do so autonomously and transparently from the user perspective.

The illustrative embodiments provide an elastic distributed graph processing system deployment with an external control plane that is responsible for controlling the resources that the graph processing system uses. The control plane responds to resource information provided by the graph processing system by “giving” resources (scaling out) or “taking away” resources (scaling in) from the graph processing system. These interactions happen behind the scenes and are not visible to the users of the system, apart from possible slowdowns in some of their workloads. Elasticity is described in terms of the number of machines (or any virtualized equivalent, such as virtual machines (VMs)) in the cluster, but the approach may be easily generalized to accommodate other resources, such as attaching more network storage or increasing the network bandwidth of an existing cluster in the cloud.

The illustrative embodiments provide a complete approach for an autonomously elastic distributed graph processing system. The illustrative embodiments dynamically scale out or scale in a distributed graph processing system based on its current hard-to-predict and temporarily spiking resource requirements in a way that supports multiple concurrent users and is transparent from a user perspective. The protocol for cluster monitoring and resizing is minimalistic, generic, and extensible, making the control plane and the graph processing system loosely coupled without making many mutual assumptions. Both the distributed graph processing system cluster and the control plane are able to follow their own policies and priorities without necessarily accommodating the other party completely, immediately, or perhaps ever.

User-invoked graph operations are not interrupted and need not wait for the cluster resizing to finish, as long as the operation can start or continue processing with the existing resources in the graph processing system. Graph operations that cannot continue due to lack of resources are merely paused and later resumed after the cluster grows, manifesting only an increased latency from a user perspective.

Determining which cluster members will participate in the operation processing is driven by extending presence of the objects involved in the operation on a just-in-time basis before the operation starts, either to the entire cluster (for resource-intensive operations) or to a unification of their current presence (for latency-sensitive operations). The objects involved in and resulting from the graph operations form a hierarchy of transitively dependent objects, which must be considered when extending their presence. The operation might need to access object dependencies as well. Extending presence of an object involves only replicating metadata and/or data of the object, which has a negligible share on the total space occupied by the object and can be done efficiently during operation invocation. This separation of small, replicated metadata/data and large partitioned data enables for the rebalancing of the actual partitioned graph data (vertices and edges) to be gradual and lazy, without blocking the user operation to start.

Using the approach of the illustrative embodiments, the distributed graph processing system can be resized automatically without system administrator intervention and dynamically with respect to immediate resource requirements of all the operations and objects handled by the system for multiple concurrent users. Resizing the cluster does not result in loss of user state or data, does not interrupt or stop the processing of user operations that do not need additional resources, and is transparent to user operations that need additional resources. User operations and previous objects created by user operations adapt to the cluster resizing gradually, minimizing the impact on operation latency by amortizing the cost of adaptation over a longer time frame.

Adding multiple machines to the cluster because of a sudden large spike in required resources might make the latency impact on the user operation noticeable, thus negatively affecting the perceived transparency of the cluster resizing from a user perspective. This can be counteracted by the initial sizing of the cluster based on the estimated user workload and the estimated size of data to be loaded into the system. Removing a machine from the cluster might take time or be refused by the graph processing system if the attempt to vacate the machine is interleaved by new user operations that again need the machine's resources. This can be counteracted by the control plane by hinting the system to prioritize resource reclamation over successful processing of user operations.

### Static Cluster Size in a Distributed Graph Processing System

Graph processing is a very challenging workload, exposing a number of key user operations on graph data, such as graph algorithms (e.g., PageRank or Shortest Path) and graph queries. For example, the operation “find the friends of my friends with whom I have the most common friends” can be expressed as a graph query in Query 1, in Property Graph Query Language (PGQL), as follows:

Query 1: “Friends of my friends with whom
I have the most common friends”

SELECT p1, p3, COUNT(*) as num_common_friends
FROM MATCH
(p1:person)-[:friend]->(p2:person)-[:friend]->(p3:person)
WHERE p1 != p3
AND NOT EXISTS ( SELECT * FROM MATCH
(p1)-[:friend]->(p3:person) )
GROUP BY p1, p3
ORDER BY num_common_friends DESC

On one hand, graph algorithms typically iterate repeatedly over the graphs and often uses some data structure abstractions, such as hash maps and priority queues inherently in their implementations. On the other hand, graph queries match patterns on the graph and, further, as seen in the above example, perform traditional relational operations, such as GROUP BY and ORDER BY. A “complete” graph processing system includes various data structures: graph, graph delta (a new snapshot of the graph after some updates, such as vertex insertions, are performed), hash maps, priority queues, tables/frames (a tabular relational structure that holds the results of the query patterns and enables relational processing, such as GROUP BY). In a distributed graph processing system, all these data structures are partitioned across the machines of the cluster.

A typical user scenario in a distributed graph processing system begins with loading and partitioning the graph data across the main memory of each machine within the cluster. An intermediate in-memory representation of graph data during loading must support efficient data transformations and exchange of vertices/edges between machines, which follows some partitioning strategy (e.g., similar number of vertices/edges located on each machine or similar histogram of vertex degrees on each machine). Compared to the final in-memory representation, these requirements make the intermediate representation typically less space-efficient because of additional temporary data annotations and preference for flexible but sparse data structures. While the overhead of the intermediate representation is usually linearly proportional to the graph data size and can be estimated in advance, using a static cluster requires users of the system to do such inconvenient estimation, and it leaves the system with overprovisioned resources after the loading is done.

Additionally, once the graph data is loaded, users can invoke various operations over this data, such as the aforementioned graph queries or graph algorithms. Similarly, as with loading, these operations tend to have intermediate state that is larger than the operation results, or even larger than the underlying graph data. Unlike the loading, the intermediate state size is often not linearly proportional to the graph data size and is therefore very difficult to estimate in advance. This applies for graph queries in particular, for which the intermediate state size heavily depends on the query structure and/or parameters and can spike significantly. With a static cluster, system users would unexpectedly face operation failures if the intermediate state of the operation does not fit the available memory. Overprovisioning of memory, and resources in general, in advance could decrease the chance of operation failure but would not guarantee success and could increase the cost for the user significantly. Furthermore, the system can use external storage (e.g., disks) to place these overflow data, but this (i) comes with performance overhead to deserialize from or serialize to disks, and (ii) still requires guess-estimating workload sizes and overprovisioning disk storage.

The aforementioned problems of static cluster sizes are further exacerbated when the in-memory distributed graph processing system is multi-user and runs in a cloud environment, with multiple per-tenant instances of such distributed system all managed by a shared control plane and using resources from a shared machine pool. Overprovisioning the resources for each instance of the system multiples the overhead with the number of tenants and could lead to severe underutilization of the shared machine pool. Having multiple users concurrently interacting with a particular instance of the system makes the resource estimations even less predictable and the actual resource usage even more spiking.

The illustrative embodiments propose autonomous elasticity, i.e., that the cluster size can dynamically adapt to the resource requirements of the distributed graph processing system, to solve the aforementioned problems. Such functionality comes with its own complexities with respect to the user experience. Preferably, the impact on the user experience should be minimal. The user should not observe any failures of the invoked operations due to lack of resources, as long as the cluster can grow to make such operations eventually succeed. If the system is multi-user, the impact on the latency of operations should be minimal as well, especially from the perspective of users whose operations do not need the cluster to resize.

### Cluster Resizing Model

The illustrative embodiments provide a control plane that works in conjunction with a component that tracks resource/memory usage and techniques for graph/data rebalancing. A resource manager is described in detail in “MEMORY-TRACKING RESOURCE MANAGER FOR ELASTIC DISTRIBUTED GRAPH-PROCESSING SYSTEM,” U.S. patent application Ser. No. 18/369,254, filed Sep. 18, 2023, the entire contents of which are hereby incorporated by reference as if fully set forth herein. Techniques for graph/data rebalancing are described in detail in “INCREMENTAL REBALANCING OF IN-MEMORY DISTRIBUTED GRAPHS FOR ELASTICITY, PERFORMANCE, AND SCALABILITY,” U.S. patent application Ser. No. 18/228,487, filed Jul. 31, 2023, the entire contents of which are hereby incorporated by reference as if fully set forth herein. The illustrative embodiments use the resource manager and rebalancing techniques to orchestrate and offer autonomous elastic (concurrent) execution of graph workloads. The example embodiments described herein focus on memory as a resource; however, the illustrative embodiments can be easily generalized to other resources.

The graph processing system receives memory resources expected to be required by a user-invoked operation. If the operation can be estimated well enough, the system reserves the memory in bulk before the start of the operation. Techniques for estimating graph size and resource consumption are described in detail in “ESTIMATING GRAPH SIZE AND MEMORY CONSUMPTION OF DISTRIBUTED GRAPH FOR EFFICIENT RESOURCE MANAGEMENT,” U.S. patent application Ser. No. 18/384,248, filed Oct. 26, 2023, the entire contents of which are hereby incorporated by reference as if fully set forth herein. If the operation cannot be estimated or if the estimation is too low, then the reservation is made gradually in smaller chunks during the operation. One approach for memory reservations and tracking for an elastic system is described in “MEMORY-TRACKING RESOURCE MANAGER FOR ELASTIC DISTRIBUTED GRAPH-PROCESSING SYSTEM,” U.S. patent application Ser. No. 18/369,254, referenced above.

An operation gets paused if the reservation cannot be made using the resources currently available in the cluster. Pausing the operation is mostly transparent to the user. The operation does not fail; rather, the operation only takes more time to finish. Pausing different graph operations, such as algorithms and queries, poses its own challenges, as described in “MEMORY-TRACKING RESOURCE MANAGER FOR ELASTIC DISTRIBUTED GRAPH-PROCESSING SYSTEM,” U.S. patent application Ser. No. 18/369,254, referenced above.

A control plane is a combination of integrated software components and an allocation of computational resources, such as memory, a node, and processes on the node for executing the integrated software components on a processor, the combination of the software and computational resources being dedicated to performing the functions described herein with respect to the control plane.

The control plane monitors each instance of the distributed graph processing system to compare the needed and available resources. If there are more needed resources than available resources, then the control plane can add machines to the cluster. If there are more available resources than needed resources (accounting for a hysteresis threshold), then the control plan can remove existing machines from the cluster. Other operations that are not paused due to lack of resources continue running. Cluster resizing does not cause these operations any interruption.

The graph processing system onboards the new resources, if more resources are added to the cluster. A resource manager detects when resources become available in the system to fulfill the reservation, such that affected operation gets resumed. Presence of all existing objects (e.g., session contexts, graphs, query results) involved in the operation gets extended to the newly joined machines. Initial partitioning of the new objects created by the operation reflects non-uniform distribution of resources. Unlike existing machines, new machines are initially empty. The user eventually observes operation completion as if nothing happened, apart from the increased latency.

All other objects within the system are eventually extended to the new machines and gradually re-partitioned until balancing goals are reached (e.g., uniformity of partition sizes). Data partitions of the objects are re-partitioned gradually in small steps in between user operations or when the system does not detect any user activity. A repartitioning/rebalancing strategy of graph objects is described in “INCREMENTAL REBALANCING OF IN-MEMORY DISTRIBUTED GRAPHS FOR ELASTICITY, PERFORMANCE, AND SCALABILITY,” U.S. patent application Ser. No. 18/228,487, referenced above.

### Example User Scenario

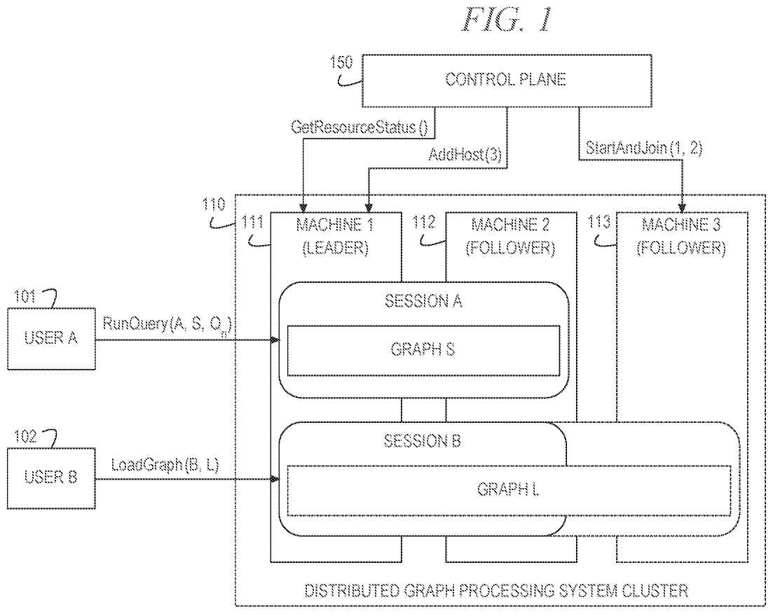

FIG. 1 is a block diagram illustrating an example elasticity scenario in which two users issue operations, triggering elasticity due to lack of memory in accordance with an illustrative embodiment. Distributed graph processing system cluster 110 starts with an initial number of machines. In the depicted example, cluster 110 starts with machine 1 (the leader111) and machine 2 (the follower 112). Control plane 150 connects to the initial cluster 110 and starts monitoring the resource usage.

User A 101 joins in session A, loads a small graph S, and starts running a sequence of graph queries Q₁, . . . , Qₙ over the graph S. User B joins in session B and starts loading a large graph L. The size of graph L is estimated to surpass the available memory of the cluster. Loading graph L is internally paused. User B is unaware that loading is paused. Control plane 150 gets a resource status from distributed graph processing system cluster 110 by sending a call (e.g., GetResourceStatus ( )) to the leader, machine 1 111. Control plane 150 detects that there is not enough memory for an operation to continue based on the resource status, orders a machine from the resource pool to join the cluster by sending a call (e.g., StartAndJoin(1, 2)) to the machine 3 113, and notifies cluster 110 to expect a new machine joining the cluster by sending a call (e.g., AddHost(3)) to the leader, machine 1 111.

Machine 3 113 establishes communication channels and synchronizes with cluster 110. Session B is extended to the new machine, and loading of graph L is resumed and runs until completion. User B observes graph loading completes successfully. In the meantime, the query sequence over graph S in session A for user A 101 runs without any interruption.

### Elastic Graph Processing System

An end-to-end elastic graph processing system must cover the following:
Graph Processing System-Control Plane Interaction: The minimum information exchange to enable the control plane to take effective elasticity decisions.
Monitoring Memory/Resource Requirements: An implementation of these interactions using memory as the resource, as well as a generalization of the approach for different types of resources. Note that memory is expected to be the most commonly used elasticity resource.
Adding Cluster Members: Growing the cluster by dynamically onboarding a new machine.
Extending Object Presence: Enables newly joined machines to “know” about the existence of objects in the graph system (e.g., different graphs). Extending object presence further dictates which machines should participate in an operation execution, depending on where the objects involved in that operation reside. Note that this involves replicated metadata and/or data sharing, whereas the “actual” partitioned graph data (i.e., vertices, edges, properties) are handled separately and lazily.
Removing Cluster Members: Shrinking the cluster by dynamically removing an existing machine.

### Graph Processing System-Control Plane Interaction

The control plane keeps the distributed graph processing system informed about the cluster growth limit, i.e., the maximum resources that the control plane is allowed or willing to give. This can be user configurable in order to control the maximum cost for the system in the cloud. Thus, the maximum resources, or growth limit, may be the maximum resources available in the resource pool or may be artificially lowered based on cost limits for the distributed graph processing system. The control plane monitors the resource usage of the system and tells the system when to grow or shrink the cluster. By updating the growth limit, the control plane signals to the distributed graph processing system the current upper bound estimate of resources available for a potential growth of the cluster. By providing resource usage and requirements, the distributed graph processing system signals to the control plane the current utilization of resources and whether it perhaps needs more within the scope of the current growth limit.

Depending on the resource type, the graph processing system requirements can be either hard or soft.

### Hard Requirements

Upon reported lack of resources, the control plane is expected, but not required, to provide additional resources to the distributed graph processing system. In the meantime, the distributed graph processing system transparently pauses user operations that require more resources to continue, reasonably believing that the control plane will provide additional machine(s). If the control plane does not react to the reported lack of resources within a configurable time limit, then the distributed graph processing system cancels the paused user operations (and notifies the user); otherwise, the operations are resumed after the cluster is given enough additional resources. If the distributed graph processing system needs resources beyond the current growth limit for the user operation to succeed, it cancels the paused/running operation right away.

Examples of hard requirements are as follows:
Memory: An operation that runs out of memory cannot continue until the extra required memory is available.
Disk storage: An operation that runs out of storage cannot continue until the extra required storage is available.

### Soft Requirements

Soft requirements are handled similarly to hard requirements, with the difference that operations are either only temporarily opportunistically waiting to receive those resources and then continue the execution either way, or do not wait at all and start the operation with lower resources until any further resources arrive.

Examples of soft requirements are as follows:
CPU: An operation predicts that it could benefit from more CPU cores. It can still operate with the current number of CPU cores, but it will likely be slower.
Network bandwidth: An operation predicts that it could benefit from higher network bandwidth. It can still operate with the current network bandwidth, but it will likely be slower.

Of course, depending on the system capabilities, some requirements can be either hard or soft. For example, requesting graphics processing unit (GPU) resources might be a hard requirement or a good-to-have (i.e., soft) requirement.

### Removing Resources

If the control plane detects that the resources (e.g., memory) currently given to the cluster are underutilized, it can ask, but not require, the distributed graph processing system to consolidate or shrink to a smaller number of machines. If the control plane must shrink the cluster in a more forceful manner, it can additionally decrease the growth limit below the current cluster size (to prevent new operations to expect growth again) and destroy some user sessions (to ensure there are enough free resources).

### Interaction

Communication is always initiated from the control plane, i.e., the control plane has the role of a client, whereas the distributed graph processing system has the role of a server. The control plane and the distributed graph processing system are loosely coupled; there is no strict contract, just a reasonable mutual expectation of behavior. How to interpret the resource requirements of the distributed graph processing system and to what degree to fulfill them are up to the control plane. How to interpret the given growth limit, how to use the given resources, and if or when to give the machines back to the control plane are up to the distributed graph processing system.

### Monitoring Memory/Resource Requirements

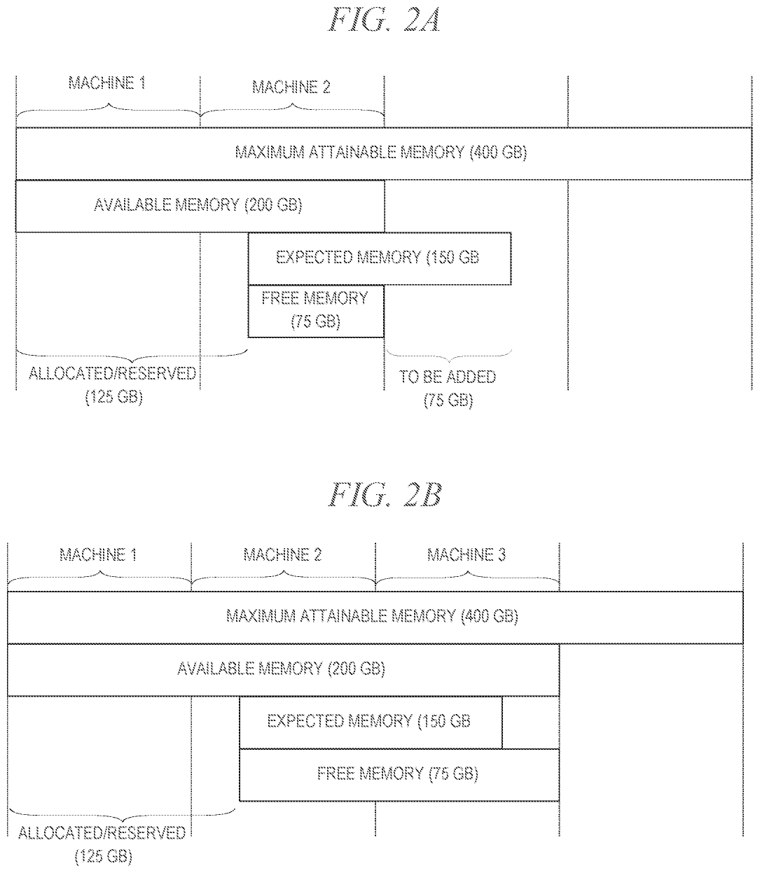

FIG. 2A illustrates an example of monitoring memory and resource requirements for a graph processing system cluster in accordance with an illustrative embodiment. Consider the control plane manages a pool of four machines, each having 100 GB of memory. The control plane informs the graph processing system that the maximum attainable memory is 400 GB. Two of the machines were already leased to the graph processing system, and the other two remain unused in the pool. The available memory of the graph processing system is therefore 200 GB, out of which 125 GB are allocated for graph data produced by previous user operations, whereas the remaining 75 GB are free memory. To satisfy the demands of an unfinished paused user operation, the graph processing system currently estimates it will need 150 GB of memory (the expected memory).

FIG. 2B illustrates an example of providing additional resources to a graph processing system for cluster resizing in accordance with an illustrative embodiment. The control plane periodically asks the graph processing system about the free and expected memory. By subtracting the free memory (75 GB) from the expected memory (150 GB), the control plane can infer that the graph processing system is currently lacking 75 GB of memory. The control plane should, therefore, join an additional machine (100 GB of memory) to the cluster. When the new machine joins the cluster in this situation, the available memory increases to 300 GB, free memory increases to 175 GB, and the expected memory stays at 150 GB. Because the expected memory is now lower than the free memory, the control plane can infer that the cluster currently has enough resources to resume the user operation.

### Generalizing to Other Resource Types

Apart from memory, the same approach can be used to other resources, such as CPU cores or network bandwidth, for example. In more general terms:
Available resources represent the physical resources currently given to the distributed graph processing system, i.e., the sum of resources of all machines of which the cluster of the system currently consists.
Free resources represent a portion of available resources not currently allocated, used, or reserved by any user operation or data objects. The amount of free resources is always less than or equal to the amount of available resources. If the portion of free resources that does not overlap with the expected resources (definition below) is greater than the resources of a single machine, then the control plane can use this as a signal to shrink the cluster.
Maximum attainable resources represent the resources that the control plane is currently allowed/willing to give to the graph processing system, if needed. If the maximum attainable resources are greater than the available resources of the graph processing system, it leads the system to an optimistic belief that the control plane is able to join additional machines to the cluster. If it is less than the available resources of the graph processing system, then the system does not expect the cluster to grow any further. Setting the maximum attainable resources below the available resources is by itself not a mandate to shrink the cluster; rather, it would simply inform the graph processing system to not pause user operations and to not expect cluster growth again after shrinking the cluster.
Expected resources represent the currently known/estimated resource demands of all the unfinished user operations within the graph processing system. For hard resource requirements (the system cannot operate without such resources), as long as it is lower than the free resources, the graph processing system is able to continue processing the user operations with the existing resources. Once it becomes greater than the free resources, the graph processing system starts pausing some user operations. The graph processing system then expects the control plane to cover the surplus by joining one or more additional machines to the cluster. Whenever the graph processing system adjusts the expected resources, it makes sure the sum of available resources and the unavailable part of the expected resources does not exceed the currently known maximum attainable resources (i.e., the system does not expect more resources than is attainable). The graph processing system can infer the expected resources in multiple ways:
   If the user operation was already paused/resumed previously, the system knows it will need at least as much peak resources as it needed during its last attempt to finish.
   For graph data in particular, the system can estimate the memory requirements in advance based on known metadata (number and types of vertex/edge properties, etc.).
   If the system cannot estimate the needed resources in advance, it reserves resources ahead in coarse grained increments (e.g., a few hundred MBs for memory).

### Adding Cluster Members

A summary of the situation just before growing the cluster is as follows:

Based on getting updated about maximum attainable resources from the control plane, the graph processing system believes it can grow and, therefore, lets expected resources go beyond free resources by pausing user operations for hard requirements (instead of cancelling them).

Based on getting updated about free resources and expected resources from the graph processing system, the control plane recognizes that the system needs one or more additional machines to join its cluster (expected resources greater than free resources).

To join a single new cluster member to the graph processing system cluster, the control plane must perform the following steps:
1. The control plane allocates an additional machine from the resource pool and starts a new process of the distributed graph processing system there (telling it hostnames of the cluster members that must be or become part of the cluster before this member).
2. The control plane notifies the graph processing system about a new cluster member joining (telling it a hostname of the newly joining cluster member).

In case many machines must join in bulk to satisfy the resource requirements, they can be allocated together in the first step so they can initialize themselves and connections with others in parallel. The graph processing system would tentatively accept/establish those connections on background as they come; however, the machines would be committed to the cluster one-by-one by repeating the second step. Before each machine is committed to the cluster, it does not participate in operation processing. This is essential for keeping the joining protocol granular (interleaving with cluster shrinking) and simple with respect to atomicity, ordering, and error handling of the joining operation (if only a subset of machines would succeed to join). The protocol could of course be generalized to support multi-machine additions.

The cluster joining operation is internally non-blocking. It simply tells the graph processing system to accept and commit connections from the new cluster member on background so that the system can handle other operations in the meantime. Growing the cluster happens atomically and transparently with respect to user operations. Those that are already running are unaware/unaffected, whereas those that are started/resumed after the new member successfully joins will observe the larger cluster. Because the actual joining operation takes some time to finish or can fail, the control plane shall repeatedly check the completion status of the joining operation. In case the joining operation completes with an exception, the control plane is expected to tear down the new cluster member process that was supposed to join and return the underlying machine back to the resource pool.

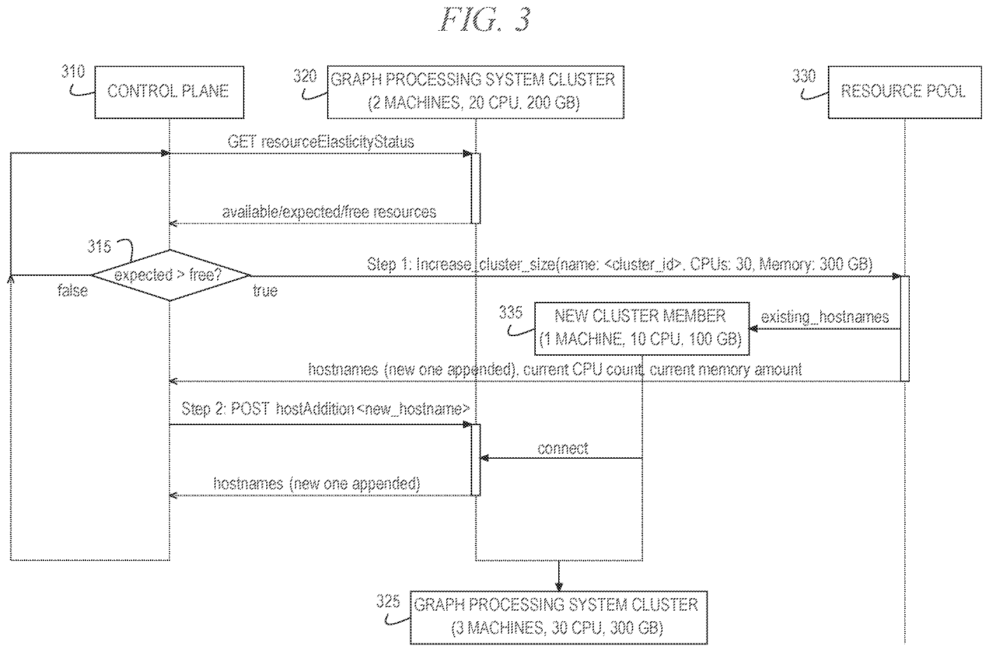

FIG. 3 is a data flow diagram illustrating an example of adding cluster members to a distributed graph processing system in accordance with an illustrative embodiment. A user attempts to load a large graph or run a graph query with large intermediate results that would not fit the current free memory of the graph processing system cluster 320. The system 320 pauses handling of the user's operation transparently (the user is not aware).

Control plane 310 requests resource status (free and expected resources) from graph processing system cluster 320 (e.g., using a GET resourceElasticityStatus call).

Graph processing system cluster 320 includes two machines with 20 CPU cores and 200 GB of memory. Graph processing system cluster 320 responds with expected and free resources, and optionally available resources. Control plane 310 then determines whether the expected resources value is greater than the free resources value (block 315). If the expected resources value is not greater than the free resources value (block 315: false), then control plane 310 does not add cluster members to graph processing system cluster 320.

If the expected resources value is greater than the free resources value (block 315: true), then control plane 310 instructs resource pool 330 to increase the cluster size (e.g., using an increase_cluster_size (name: <cluster_id>, CPUs: 30, Memory: 300 GB) call). Resource pool 330 allocates a new cluster member 335, which includes one machine having 10 CPU cores and 100 GB of memory. Resource pool 330 notifies new cluster member 335 of the existing host names and notifies control plane 310 of the host names, including new cluster member 335, the current CPU count, and the current memory amount.

Control plane 310 then notifies graph processing system cluster 320 of the new hostname (e.g., using POST hostAddition<new_hostname> call). Newly started cluster member 335 connects to all other cluster members within the graph processing system using the list provided by resource pool 330. Graph processing system 320 then notifies control plane 310 of the hostnames, with new cluster member 335 included.

The resulting graph processing system cluster 325 now includes three machines, 30 CPU cores, and 300 GB of memory. Now, the cluster size is increased, the user's paused graph loading operation or query request transparently resumes handling and runs until completion (unless even more resources are needed). The user perceives increased latency of handling the request, but the cluster resizing is transparent.

### Extending Object Presence

When a user connects to the graph processing system, a session (represented by a session object) is created for the user. When the user later invokes a graph data loading operation, the result of the operation is a graph object associated with (or rather dependent on) the user's session. Subsequent operations like graph queries executed over the graph can create result objects that can be either derived from (and therefore dependent on) the graph, or independent of the graph, which means they are dependent only on the session. The object dependencies can be nested (e.g., graph data lineage consisting of multiple incremental graph data snapshots) or transitive (e.g., vertex/edge collection resulting from filtering the graph or from filtering another vertex/edge collection).

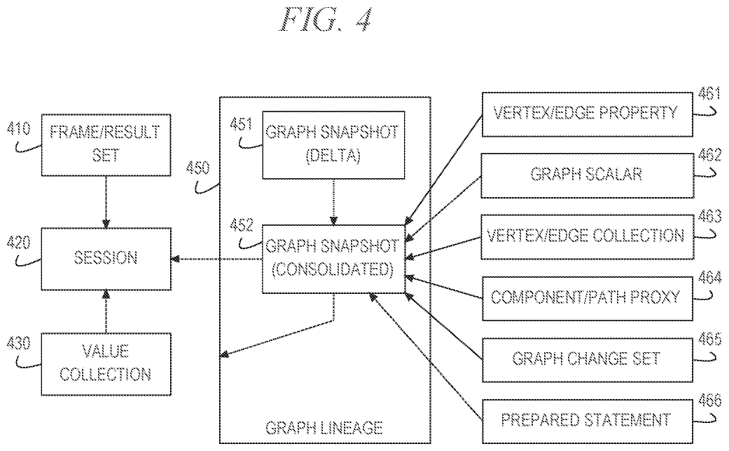

The described object dependency plays a role when invoking operations on or with the objects (the operation might need access to all the objects up the dependency hierarchy as well) or when deleting the objects (the objects down the dependency hierarchy would be deleted as well). FIG. 4 illustrates an example of an object dependency hierarchy with different types of dependency relationships in accordance with an illustrative embodiment. Types of dependency relationships may include, for example, just metadata dependency or an actual data dependency.

As shown in FIG. 4, frame or result set 410, value collection 430, and graph lineage 450 have metadata dependencies on session 420, as represented by dashed lines. Within graph lineage 450, graph snapshot (delta) 451 has a data or hash partition dependency on graph snapshot (consolidated 452), as represented by the dotted line. Graph scalar 462 and prepared statement 466 have metadata dependencies on graph snapshot 452, as represented by dashed lines. Vertex/edge property 461, vertex/edge collection 463, component/path proxy 464, and graph change set 465 have both metadata dependencies and data or hash partition dependencies on graph snapshot 452, as represented by solid lines in FIG. 4.

In the context of a distributed graph processing system, each object consists of replicated metadata (identifiers, handles, descriptors, annotations, class instances, etc.), replicated data (e.g., high-degree vertices, dictionary strings) and partitioned data (e.g., all other vertices/edges and their properties in the graph). Both replicated metadata and replicated data of a particular object must be copied (extended) to a newly joined cluster member; otherwise, the new cluster member cannot participate in processing user operations involving this particular object. In case such object is dependent on other objects, these must be extended as well before operation processing. As for partitioned data, the data partition of the object on the newly joined cluster member can be initially empty and only increase its share later during gradual rebalancing as described in “INCREMENTAL REBALANCING OF IN-MEMORY DISTRIBUTED GRAPHS FOR ELASTICITY, PERFORMANCE, AND SCALABILITY,” U.S. patent application Ser. No. 18/228,487, referenced above.

The trigger for extending the object is the realization that it is not present on the cluster member that should be involved in processing a user operation that is directly or indirectly using the object. For this purpose, each object is associated with a group membership descriptor, which describes on which cluster members the object is already present. Group membership descriptor can be implemented for example as a Boolean array or as a hostname list. Group membership descriptors do not need to be replicated; it is sufficient that they are present only on the cluster member who has a leader role (i.e., accepts user requests and coordinates user operation processing). Upon receiving the user request, but before invoking the operation processing, the cluster leader first determines the set of objects required by the operation based on the object dependency hierarchy, and then calculates a group membership descriptor for the operation based on the group membership descriptors of the involved objects. For operations that were perhaps previously paused due to lack of resources, it might be desirable to extend the group membership descriptor of the resumed operation to all cluster members. For other operations (especially those with small resource footprint and preference for low-latency processing), it might be sufficient to use just a union of the group membership descriptors of the involved objects (i.e., extend the objects to the same subset of cluster members, but not more than necessary). Once the group membership descriptor of the operation is determined, the replicated metadata/data can be then serialized and broadcasted along with the operation invocation across the cluster, so that the other cluster members involved in the operation can build the presence of missing objects.

New objects that are supposed to be created as a result of the operation (or existing objects that are supposed to be spread uniformly across the cluster by a periodic background rebalancing) are a special case when determining their intended group membership descriptor, as it is generally desirable to extend such objects as much as possible to leverage new resources (to the entire cluster or as much as the dependency hierarchy allows). Another special case are session objects-those shall be preventively extended to the entire cluster as well, as they are on top of the dependency hierarchy and there would therefore eventually be a user operation needing full cluster presence (e.g., when loading a new graph data). It should however be done only when dispatching the next user operation, to avoid interrupting current user operation that is processed concurrently with the cluster resizing. To still allow processing the user operation only on a subset of the cluster, despite the session being fully extended, the resulting union of all involved object group membership descriptors should be intersected with the session's group membership descriptor. The operation invocation would propagate to wherever the session is extended but would carry a descriptor of the union group membership, so that each cluster member could determine if it should participate in the operation or not.

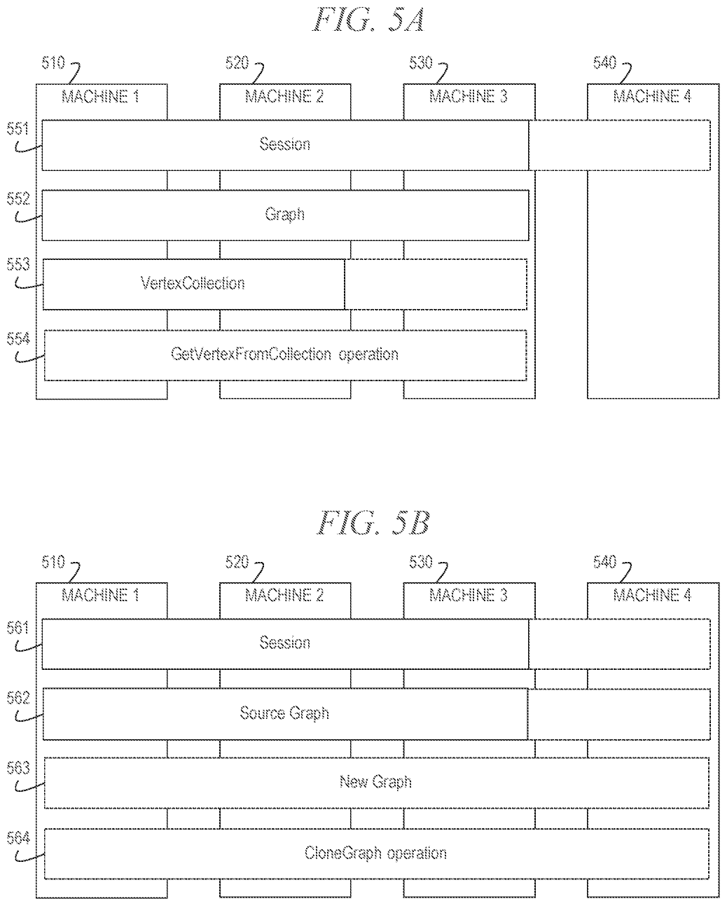

FIG. 5A illustrates an example of determining a group membership descriptor for an operation retrieving a vertex from a vertex collection in accordance with an illustrative embodiment. FIG. 5B illustrates an example of determining a group membership descriptor for an operation cloning a graph in accordance with an illustrative embodiment. In both situations, the new cluster member (machine 4 540) recently joined the cluster, and the session (551 in FIG. 5A; 561 in FIG. 5B) extends to machine 4 540 as part of the operation.

Operation 554 in FIG. 5A retrieves a vertex from a vertex collection 553. The vertex collection object 553 is dependent on (derived from) the graph object 552. The collection was created back when the cluster still consisted of only two machines (machine 1 510 and machine 2 520), and the collection was not involved in an operation since being created. The graph on the other hand was involved in some operations in the meantime and is therefore extended to the third machine (machine 3 530) as well. Because getting a single vertex from the collection is not resource intensive and the user probably expects the operation 554 to have low latency, it is sufficient to extend the vertex collection object 553 only as much as the graph is already extended. The group membership descriptor for the operation would therefore involve only three machines 510, 520, 530, not leveraging the recently joined fourth cluster member (machine 4 540).

Operation 564 in FIG. 5B clones a graph 552, which is currently extended on three machines (machine 1 510, machine 2 520, machine 3 530). Because cloning a graph might require a lot of resources, the group membership descriptor of the new graph is set to leverage the recently joined fourth machine. The original source graph 562, therefore, must be extended to the fourth machine (machine 4 540) before operation 564 can be processed. Therefore, just as session 561 is extended to machine 4 540, source graph 562, new graph (result of graph cloning) 563, and operation 564 are extended to machine 4 540.

### Removing a Cluster Member

Based on getting updated about free resources and expected resources from the graph processing system, the control plane can recognize that the system could accommodate all the existing user data and operations with a lower number of cluster members (a portion of free resources that does not overlap with the expected resources is meaningfully larger than the resources of a single machine or multiple machines, where the term “meaningfully” typically means to have some hysteresis margin to avoid quick succession of growing/shrinking if the resource usage oscillates around the boundary of two machines).

Asking the graph processing system to decrease the size of its cluster will cause the system to gradually rebalance all the user data (graphs, query results, etc.) away from the cluster member(s) chosen to be removed. The control plane shall not expect an immediate effect-freeing the chosen cluster member(s) might take some time, because gradual rebalancing might be interleaved with new user operations. Data rebalancing is described in detail in “INCREMENTAL REBALANCING OF IN-MEMORY DISTRIBUTED GRAPHS FOR ELASTICITY, PERFORMANCE, AND SCALABILITY,” U.S. patent application Ser. No. 18/228,487, referenced above.

In a similar manner (and for similar reasons) as with the joining protocol, if multiple cluster members are to be removed in bulk, the control plane must request the graph processing system to remove them in separate individual requests (one request per each leaving cluster member). While these requests can be invoked in parallel, so that the graph processing system is aware approximately how much in total the cluster is supposed to shrink and can therefore avoid repeated data rebalancing, the requests will be responded to one-by-one respecting the ordering, atomicity, and potential refusal/failure of the individual members to leave the cluster of the graph processing system.

If the maximum attainable resources value is set low enough to not include the resources of the chosen member(s), the cluster can additionally cancel any paused/running user operations whose expected resources would otherwise require the cluster member to stay. If it is determined that neither rebalancing nor operation cancelling would lead to vacating a cluster member, the shrinking operation is refused by the cluster. To further increase (or rather enforce) probability of shrinking to succeed, the control plane can destroy entire user sessions to free up resources (which session to destroy can be decided based on billing schemes, prioritization, or idle time, for example).

Once a leaving cluster member does not host any data, existing cluster members can terminate the communication channels with the leaving member and exclude it from the cluster. The cluster shrinking operation is internally non-blocking; it just triggers the graph processing system to exclude the leaving cluster member on background so that the system can handle other user operations in the meantime. Shrinking the cluster happens atomically and transparently with respect to user operations-those that are already running are unaware/unaffected (because they already run on a subset of machines that are unaffected), whereas those that are started/resumed after the cluster member leaves will observe the smaller cluster. Once the chosen cluster member leaves the cluster, the control plane is expected to tear down the cluster member process that left and return the underlying machine back to the resource pool.

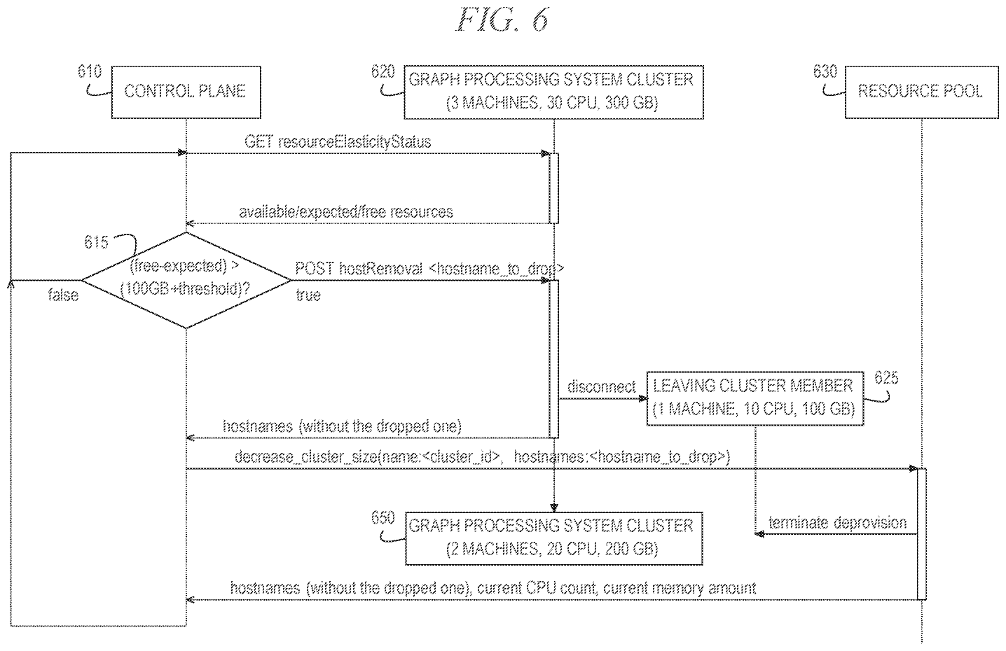

FIG. 6 is a data flow diagram illustrating an example of removing a cluster member from a distributed graph processing system in accordance with an illustrative embodiment. A user finishes a graph query with large intermediate results or a user session with a large graph is destroyed after inactivity. The graph processing system 620 now has a significant surplus of free resources (more than the resources of one machine).

Control plane 610 requests resource status (free and expected resources) from graph processing system cluster 620 (e.g., using a GET resourceElasticityStatus call). Graph processing system cluster 620 includes three machines with 30 CPU cores and 300 GB of memory. Graph processing system cluster 620 responds with expected and free resources, and optionally available resources. Control plane 610 then determines whether the free minus expected resources value is greater than 100 GB (resources of one machine) plus a threshold (block 615). If the free minus expected resources value is not greater than 100 GB plus a threshold (block 315: false), then control plane 610 does not remove any cluster members from graph processing system cluster 620.

If the free minus expected resources value is greater than 100 GB plus a threshold (block 315: true), then control plane 610 instructs graph processing system 620 to remove a machine (e.g., using a POST hostRemoval <hostname_to_drop> call). Graph processing system 620 then disconnects the leaving cluster member 625 and notifies control plane 610 of the hostnames in the cluster, minus the leaving cluster member 625.

Data are balanced away from the leaving member 625 to the members that stay. The leaving member 625 stops participating in handling the user's requests. The connections with the other cluster members are closed. Control plane instructs resource pool 630 of the decreased cluster size (e.g., using a decrease_cluster_size (name: <cluster_id>, hostnames: <hostname_to_drop>) call). Resource pool 630 then terminates and deprovisions the leaving cluster member 625.

The resulting graph processing system cluster 650 now includes two machines, 20 CPU cores, and 200 GB of memory. Resource pool 630 then notifies control plane 610 of the hostnames, without the leaving cluster member 625, the current CPU count, and the current memory count.

### Procedural Overview

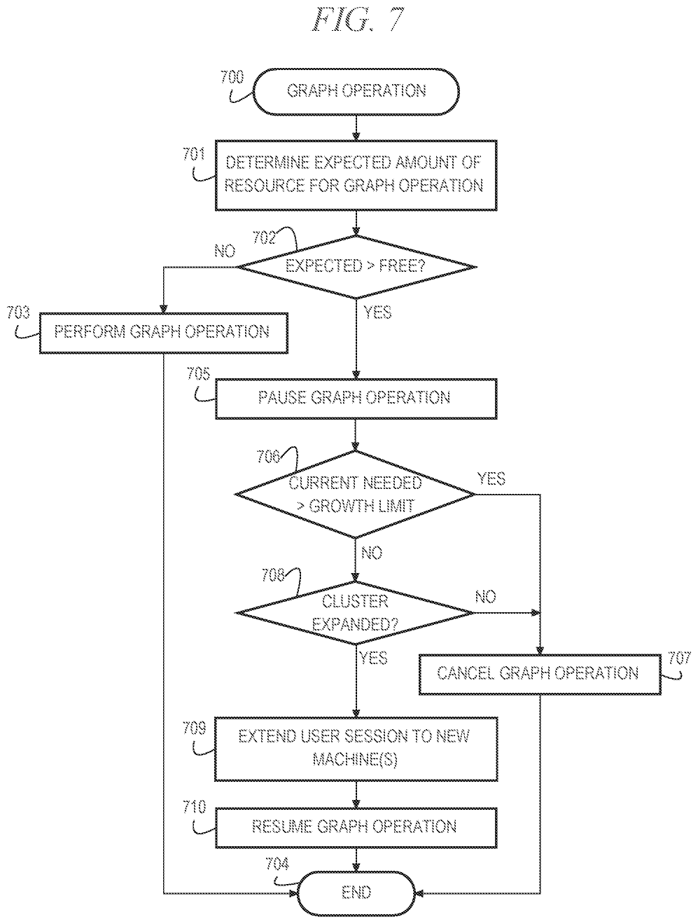

FIG. 7 is a flowchart illustrating of a graph processing system performing a graph operation with autonomous transparent cluster resizing in accordance with an illustrative embodiment. Operation begins with a graph processing system initiating a graph operation (block 700). The graph processing system determines an expected amount of a resource for the graph operation (block 701). The graph operation may be, for example, a graph loading operation, a graph query, or a graph algorithm. In one embodiment, the resource may be a resource with a hard requirement, such as memory. That is, if the graph processing system does not have enough of the resource, then the operation must be paused until the cluster is resized to increase the available amount of the resource.

The graph processing system determines whether the expected resource value is greater than the free resource value (block 702). The free resource amount is the amount of available resource that is not allocated or reserved for processing an operation. If the expected resource value is not greater than the free resource value (block 702: NO), then the graph processing system performs the graph operation (block 703), and operation ends (block 704). Once this operation has begun processing, the operation will not be affected by subsequent operations exceeding the available resource amount.

If the expected resource value is greater than the free resource value (block 702: YES), then the graph processing system pauses the graph operation (block 705). In one embodiment, the graph operation is paused only if the resource has a hard resource requirement. If the resource has a soft requirement (e.g., CPU cores, network bandwidth), then the graph processing system can start processing the graph operation using the available resources.

The graph processing system determines whether the current needed resources for all processing and paused operations is greater than the growth limit (block 706). The control plane communicates a maximum attainable resources value that represents the total amount of the resource available to the graph processing system. The maximum attainable resources value may be based on the total amount of the resource in the resource pool or may be capped by a total desired cost incurred by the graph processing system. If the current needed resources amount is greater than the growth limit (block 706: YES), then the graph processing system cancels the graph operation (block 707) (for a hard resource requirement), and operation ends (block 704). Note that for a soft resource requirement, the graph processing system may continue processing the graph operation. The user may experience latency with the graph operation.

If the current needed resource amount is not greater than the growth limit (block 706: NO), then the graph processing system determines whether the cluster has been expanded (block 708). If a period of time elapses without the control plane expanding the cluster size by adding one or more machines to the cluster (block 708: NO), then the graph processing system cancels the graph operation (block 707) (for a hard resource requirement), and operation ends (block 704). Again, for a soft resource requirement, the graph processing system may continue processing the graph operation.

If the control plane expands the cluster by adding one or more machines (block 708: YES), then the graph processing system extends the user session to the new machine(s) (block 709) and resumes the graph operation (block 710). Thereafter, operation ends (block 704).

### DBMS Overview

A database management system (DBMS) manages a database. A DBMS may comprise one or more database servers. A database comprises database data and a database dictionary that are stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically marked data objects; however, the hierarchically marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

In a DOCS, a database command may be in the form of functions or object method calls that invoke CRUD (Create Read Update Delete) operations. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables, and other information.

A database server includes multiple database processes. Database processes run under the control of the database server (i.e., can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g., shared access to a set of disk drives and data blocks stored thereon. The nodes in a multi-node database system may be in the form of a group of computers (e.g., workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance.” A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the attribute names and data types of the attributes, and one or more files or portions thereof that store data for the table. Metadata in the database dictionary defining a procedure may specify a name of the procedure, the procedure's arguments and the return data type, and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e., .java file) and the compiled version of the class (i.e., .class file).

Native data types are data types supported by a DBMS “out-of-the-box.” Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as valid data types and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

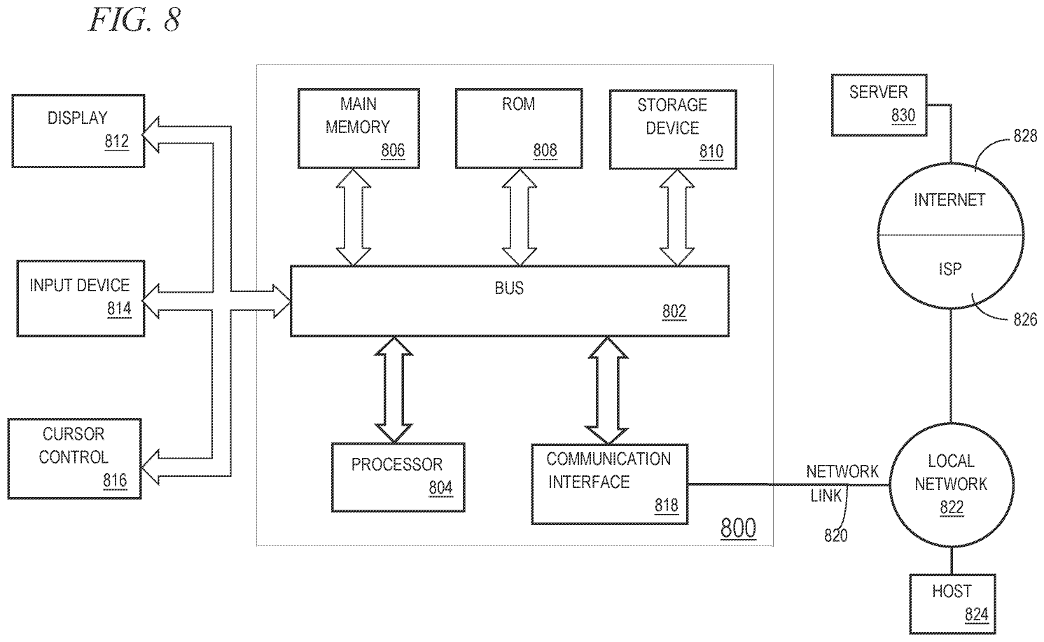

For example, FIG. 8 is a block diagram that illustrates a computer system 800 upon which aspects of the illustrative embodiments may be implemented. Computer system 800 includes a bus 802 or other communication mechanism for communicating information, and a hardware processor 804 coupled with bus 802 for processing information. Hardware processor 804 may be, for example, a general-purpose microprocessor.

Computer system 800 also includes a main memory 806, such as a random-access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or solid-state drive is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 810. Volatile media includes dynamic memory, such as main memory 806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic, or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world-wide packet data communication network now commonly referred to as the “Internet” 828. Local network 822 and Internet 828 both use electrical, electromagnetic, or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### Software Over View

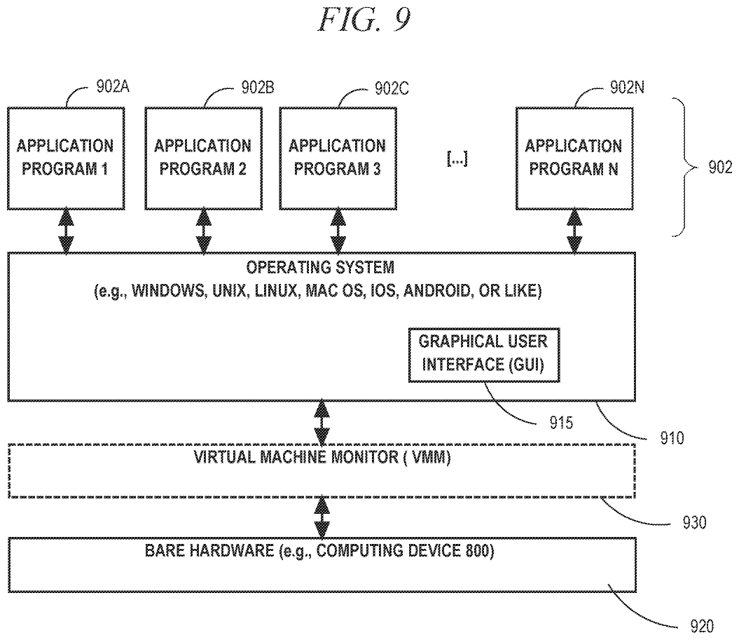

FIG. 9 is a block diagram of a basic software system 900 that may be employed for controlling the operation of computer system 800. Software system 900 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 900 is provided for directing the operation of computer system 800. Software system 900, which may be stored in system memory (RAM) 806 and on fixed storage (e.g., hard disk or flash memory) 810, includes a kernel or operating system (OS) 910.

The OS 910 manages low-level aspects of computer operation, including managing execution of processes, memory allocation, file input and output (I/O), and device I/O. One or more application programs, represented as 902A, 902B, 902C . . . 902N, may be “loaded” (e.g., transferred from fixed storage 810 into memory 806) for execution by system 900. The applications or other software intended for use on computer system 800 may also be stored as a set of downloadable computer-executable instructions, for example, for downloading and installation from an Internet location (e.g., a Web server, an app store, or other online service).

Software system 900 includes a graphical user interface (GUI) 915, for receiving user commands and data in a graphical (e.g., “point-and-click” or “touch gesture”) fashion. These inputs, in turn, may be acted upon by the system 900 in accordance with instructions from operating system 910 and/or application(s) 902. The GUI 915 also serves to display the results of operation from the OS 910 and application(s) 902, whereupon the user may supply additional inputs or terminate the session (e.g., log off).

OS 910 can execute directly on the bare hardware 920 (e.g., processor(s) 804) of computer system 800. Alternatively, a hypervisor or virtual machine monitor (VMM) 930 may be interposed between the bare hardware 920 and the OS 910. In this configuration, VMM 930 acts as a software “cushion” or virtualization layer between the OS 910 and the bare hardware 920 of the computer system 800.

VMM 930 instantiates and runs one or more virtual machine instances (“guest machines”). Each guest machine comprises a “guest” operating system, such as OS 910, and one or more applications, such as application(s) 902, designed to execute on the guest operating system. The VMM 930 presents the guest operating systems with a virtual operating platform and manages the execution of the guest operating systems.

In some instances, the VMM 930 may allow a guest operating system to run as if it is running on the bare hardware 920 of computer system 800 directly. In these instances, the same version of the guest operating system configured to execute on the bare hardware 920 directly may also execute on VMM 930 without modification or reconfiguration. In other words, VMM 930 may provide full hardware and CPU virtualization to a guest operating system in some instances.

In other instances, a guest operating system may be specially designed or configured to execute on VMM 930 for efficiency. In these instances, the guest operating system is “aware” that it executes on a virtual machine monitor. In other words, VMM 930 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
performing one or more operations in a first user session using a cluster of machines in a distributed graph processing system, wherein:
the cluster of machines has a first number of machines providing a first available amount of a resource,
the first available amount of the resource includes a first free amount of the resource that is not allocated, used, or reserved by one or more previous user operations or data objects in the distributed graph processing system,
the one or more operations are estimated to use an expected amount of the resource,
a control plane adds one or more new machines to the cluster of machines to form a second number of machines in response to the expected amount of the resource being greater than the first free amount of the resource,
the second number of machines provide a second available amount of the resource including a second free amount of the resource, and
performing the one or more operations comprises:
extending the first user session to the one or more new machines in response to the second free amount of the resource being greater than the expected amount of the resource; and
performing the one or more operations in the extended first user session,
wherein the method is performed by one or more computing devices.

2. The method of claim 1, wherein performing the one or more operations comprises:
pausing a given operation within the one or more operations in response to the expected amount of the resource being greater than the first free amount of the resource; and
resuming the given operation in the extended first user session in response to the second free amount of the resource being greater than the expected amount of the resource.

3. The method of claim 2, wherein the resource comprises memory or disk storage.

4. The method of claim 2, wherein the one or more operations include a second operation that is performed without interruption.

5. The method of claim 1, wherein the distributed graph processing system communicates the first free amount of the resource and the expected amount of the resource to the control plane.

6. The method of claim 1, wherein:
the control plane communicates a maximum amount of the resource in a pool of machines, and
the distributed graph processing system determines that a sum of the first available amount of the resource and an unavailable portion of the expected amount of the resource does not exceed the maximum amount of the resource.

7. The method of claim 1, wherein each operation within the one or more operations is a graph loading operation, a graph query operation, or a graph processing algorithm.

8. The method of claim 1, wherein the one or more previous user operations are performed in a second user session.

9. The method of claim 1, wherein:
a given operation within the one or more operations has a graph object associated with the first user session and one or more dependent objects that depend on the graph object, and
performing the one or more operations in the extended first user session comprises extending the graph object and the one or more dependent objects to machines within the cluster of machines based on a hierarchy of dependencies.

10. The method of claim 1, wherein the resource comprises processor cores or network bandwidth.

11. A method comprising:
monitoring a distributed graph processing system by a control plane, wherein:
a cluster of machines is allocated to the distributed graph processing system, the cluster of machines has a first number of machines providing a first available amount of a resource,
monitoring the distributed graph processing system comprises receiving a first free amount of the resource and an expected amount of the resource from the distributed graph processing system,
the first free amount of the resource represents an amount of the first available amount of the resource that is not allocated, used, or reserved by one or more previous user operations or data objects in the distributed graph processing system,
the expected amount of the resource represents an amount of the resource that one or more operations are estimated to use, and
monitoring the distributed graph processing system further comprises adding a new machine from a resource pool to the cluster of machines to form a second number of machines in response to the expected amount of the resource being greater than the first free amount of the resource,
wherein the method is performed by one or more computing devices.

12. The method of claim 11, wherein monitoring the distributed graph processing system further comprises removing a given machine from the cluster of machines in response to the first available amount of the resource being greater than the first free amount of the resource by an amount of the resource in the given machine.

13. One or more non-transitory storage media storing instructions which, when executed by one or more computing devices, cause:
performing one or more operations in a first user session using a cluster of machines in a distributed graph processing system, wherein:
the cluster of machines has a first number of machines providing a first available amount of a resource,
the first available amount of the resource includes a first free amount of the resource that is not allocated, used, or reserved by one or more previous user operations or data objects in the distributed graph processing system,
the one or more operations are estimated to use an expected amount of the resource,
a control plane adds one or more new machines to the cluster of machines to form a second number of machines in response to the expected amount of the resource being greater than the first free amount of the resource,
the second number of machines provide a second available amount of the resource including a second free amount of the resource, and
performing the one or more operations comprises:
extending the first user session to the one or more new machines in response to the second free amount of the resource being greater than the expected amount of the resource; and
performing the one or more operations in the extended first user session.

14. The one or more non-transitory storage media of claim 13, wherein performing the one or more operations comprises:
pausing a given operation within the one or more operations in response to the expected amount of the resource being greater than the first free amount of the resource; and
resuming the given operation in the extended first user session in response to the second free amount of the resource being greater than the expected amount of the resource.

15. The one or more non-transitory storage media of claim 14, wherein the resource comprises memory or disk storage.

16. The one or more non-transitory storage media of claim 14, wherein the one or more operations include a second operation that is performed without interruption.

17. The one or more non-transitory storage media of claim 13, wherein the distributed graph processing system communicates the first free amount of the resource and the expected amount of the resource to the control plane.

18. The one or more non-transitory storage media of claim 13, wherein:
the control plane communicates a maximum amount of the resource in a pool of machines, and
the distributed graph processing system determines that a sum of the first available amount of the resource and an unavailable portion of the expected amount of the resource does not exceed the maximum amount of the resource.

19. The one or more non-transitory storage media of claim 13, wherein each operation within the one or more operations is a graph loading operation, a graph query operation, or a graph processing algorithm.

20. The one or more non-transitory storage media of claim 13, wherein:
a given operation within the one or more operations has a graph object associated with the first user session and one or more dependent objects that depend on the graph object, and
performing the one or more operations in the extended first user session comprises extending the graph object and the one or more dependent objects to machines within the cluster of machines based on a hierarchy of dependencies.
